(19) United States
(12) Patent Application Publication
(10) Pub. No.: US 2009/0228918 A1
(43) Pub. Date: Sep. 10, 2009

(54) Content recommender

(75) Inventors: Anders Rolff, Bray (IE); Paul Cotter, Stillorgan (IE); Keith Joseph Bradley, Sandyford (IE)

Correspondence Address: Zilka-Kotab, PC, P.O. BOX 721120, SAN JOSE, CA, 95172-1120, US

(73) Assignee: ChangingWorlds Ltd., Leopardstown (IE)

(21) Appl. No.: 12/074,574

(22) Filed: Mar. 5, 2008

(51) Int. Cl. H04N 7/025

(52) U.S. Cl. 725/34

(57) ABSTRACT

A method for making an online content recommendation. In one embodiment, the method includes the steps of: providing a plurality of data source modules having data; providing a plurality of function modules, each function module adapted to be connected to at least one of the plurality of data source modules and other function modules; receiving a recommendation request; dynamically connecting at least one of the plurality of the data source modules and at least one of the plurality of function modules in response to the recommendation request; and generating the recommendation by using the connected at least one data source module and the at least one function module.

### FIELD OF THE INVENTION

The invention relates to the field of providing recommendations. Specifically, the invention relates to an online recommendation system for providing personalized content recommendations to a user.

### BACKGROUND OF THE INVENTION

Given the amount of information currently available on the Internet and the pace on which the Internet is growing, it is essential for online content providers to be able to ensure that users are only presented with content items that are genuinely relevant and timely. In this way users will spend less time filtering content items in which they have no interest and be able to focus on the ones in which they are interested. User experience can be improved significantly if web portals are able to make content recommendations seamlessly to each user. Until now website designers have been in search for an effective way to target their content to interested users based on information available on the users, such as their online profiles or past browsing activities.

However, there has not been a recommendation system that is capable of dynamically creating recommendation strategies in response to a recommendation request based on the type of the request received and the resources available. The existing recommendation systems provide neither the flexibility in terms of the type of content they recommend nor the scalability to accommodate the ever increasing number of underlying recommendation strategies that are becoming available.

The present invention addresses this need.

### SUMMARY OF THE INVENTION

In one aspect, the invention relates to a method for making an online content recommendation. In one embodiment, the method includes the steps of: providing a plurality of data source modules having data; providing a plurality of function modules, each function module adapted to be connected to at least one of the plurality of data source modules and other function modules; receiving a recommendation request; dynamically connecting at least one of the plurality of the data source modules and at least one of the plurality of function modules in response to the recommendation request; and generating the recommendation by using the connected at least one data source module and the at least one function module.

In another embodiment, the method further includes the step of creating a recommendation specification, the recommendation specification defining at least one data source module and at least one function module for making the recommendation in response to the recommendation request. In yet another embodiment, the method further includes the step of receiving user feedback on the recommendation. In yet another embodiment, at least one of the plurality of data source modules includes a user profile. In yet another embodiment, at least one of the plurality of data source modules includes an item profile. In yet another embodiment, at least one of the plurality of function modules is a filter module. In yet another embodiment, at least one of the plurality of function modules is a strategy module. In yet another embodiment, at least one of the plurality of function modules is a hybrid strategy module. In yet another embodiment, the recommendation is a personalized advertisement. In yet another embodiment, the recommendation is a personalized search result. In still yet another embodiment, the method further includes the step of caching the recommendation with respect to the user and the user action.

In another aspect, the invention relates to a system for making an online content recommendation. In one embodiment, the system includes a plurality of data source modules having data; a plurality of function modules, each function module adapted to be connected to at least one of the plurality of data source modules and other function modules; a recommendation request receiving module adapted to receive a request for recommendations; a recommendation factory adapted to dynamically assemble at least one of the plurality of function modules and at least one of the plurality of data source modules in response to the recommendation request, the recommendation factory in communication with the recommendation request receiving module; and an online recommender for generating a recommendation using the assembled at least one function module and at least one data source module, the online recommender in communication with the recommendation factory.

In another embodiment, the system further comprises a recommendation specification generator adapted to generate a recommendation specification in response to the request for recommendation, the recommendation specification generator in communication with the user input module. In yet another embodiment, the system further includes a feedback handler for managing user feedbacks in response to the recommendation. In yet another embodiment, at least one of the data source modules includes a user profile. In yet another embodiment, at least one of the plurality of data source modules includes an item profile. In yet another embodiment, at least one of the plurality of function modules is a filter module. In yet another embodiment, at least one of the plurality of function modules is a strategy module. In yet another embodiment, at least one of the plurality of function modules is a hybrid strategy module. In yet another embodiment, the recommendation is a personalized advertisement. In yet another embodiment, the recommendation is a personalized search result. In yet another embodiment, the system further includes a caching module adapted to cache the recommendation with respect to the user and the user request. In yet another embodiment, the recommendation request receiving module is adapted to receive search results from a search engine. In still yet another embodiment, the recommendation request receiving modules is adapted to communicate with an advertisement provider.

The methods are explained through the following description, drawings, and claims.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1 is a block diagram illustrating the modules of a recommendation architecture according to an embodiment of the present invention;

FIG. 2 is a block diagram illustrating the modules of a recommendation architecture and the steps of connecting the modules to generate an advertisement recommendation specification according to an embodiment of the invention;

FIG. 3 is a block diagram illustrating the modules of a recommendation architecture and the steps of connecting the modules to generate a search result recommendation specification according to an embodiment of the invention;

FIG. 4 is a block diagram illustrating the various hardware components of a recommendation architecture in accordance with an embodiment of the invention; and

FIG. 5 is a block diagram illustrating a set of cache modules for caching recommendations of a recommendation architecture in accordance with an embodiment of the present invention.

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

In general overview, the methods and systems disclosed in this invention relate to a recommendation architecture that allows filters, strategies and other types of function modules to be plugged together dynamically to create customized recommendation specifications. These specifications can then be used to generate recommendations for individual users of a web portal. A detailed description of the different modules and the steps of generating recommendation specifications are provided later in this document. Embodiments of the disclosed recommendation architecture are suitable for generating recommendations of different types of online content items, such as web pages, advertisements and search results. The content items may be in different formats, such as video clips, downloadable image files and ringtones.

The flexibility of the disclosed recommendation architecture enables it to generate intelligent recommendations based on multiple recommendation strategies, such as collaborative based recommendation strategies and content based recommendation strategies. A content based recommendation strategy is based on a user's historic preferences of content items made available to the user. As used herein, the term “user community preference” (UCP) refers to a way of profiling a user's interests based on his behavior and usage of a web portal. Portals, by nature, provide various types of information to their users. Typically, a web portal includes multiple portal nodes such as news, entertainment, finance and sports and provides a way for the user to navigate from one node to another. The user's activity on a portal is usually tracked by the web server hosting the portal and recorded in the form of a user profile. This profile details which portal nodes the user has visited and the frequency of the visits. By assigning categories to the portal nodes representative of their respective content type, and then associating this information with the user profile, a holistic view of the user's interests can be built based on his activities on the portal. The general information about the user's interests can be used to predict in what that user will likely be interested in the future. Additionally, because the profile is holistic, recommendations are not limited to web portal content but can also be used to predict the user's interests in a variety of off-portal items.

In contrast to a content based recommendation strategy, collaborative based recommendation strategies are built on the concept that similar users often enjoy or purchase the same content items on a web portal. Similar users can be identified by comparing their UCPs and selecting the users having high degrees of overlaps between their UCPs. For example, if a user's UCP indicates that he is interested in web pages relating to sports and science fiction and other users who are interested in sports and science fiction pages are also interested in the electronic gadgets section of the portal, a recommendation of the electronic gadgets section will be made to the first user based on a collaborative based recommendation strategy.

In addition to content based and collaborative based recommendation strategies, there are a number of other types of strategies, including, for example, current context based recommendation strategy and geographical context based recommendation strategy. A current context based recommendation strategy is built upon the assumption that a user is interested in content items that are similar to the item that he is currently viewing. For example, if a user is browsing a web page dedicated to baseball news, other content items related to baseball would be recommended. A geographical context based recommendation strategy generates recommendations based on the user's current location. For example, results from a search for movie theaters can be recommended based on each movie theater's proximity to the user's location based on a geographical context based recommendation strategy.

The different types of recommendation strategies can be combined to form a hybrid strategy for the purpose of generating intelligent recommendations. For example, web-based TV programs may be targeted based on what people with similar tastes enjoy watching using collaborative based recommendation strategy. The TV programs may also be targeted based on how well a candidate program's profile matches the user's UCP using a content based recommendation strategy. By applying a collaborative/content hybrid recommendation strategy, the recommendation architecture will not only recommend to a user a first TV show which is popular amongst people having similar UCPs to the user's own, but also recommend a second TV show to the user because the profile of the second TV show matches the user's individual UCP. The recommendation architecture is able to recognize, based on the hybrid recommendation strategy, that the user could still be interested in the second TV show even if the second show is not popular amongst other similar users. In contrast, new TV shows not yet seen by a user community often do not get recommended by a purely collaborative based recommendation system because there is no data reflecting other users' interest in the show. However, a hybrid recommendation strategy with a content base component guarantees consideration of the new shows when recommendations are made by only requiring data on the target user and the show itself.

In addition to recommending content items to users, the recommendation architecture is also adapted to recommend users to other users. This user-to-user recommendation function is useful, especially to a social networking website, for associating like-minded users who share the same interests. Once associated, these like-minded users could become recommendation partners in generating collaborative based recommendations for each other. Further, user-to-user recommendations can be tempered by the degree of similarities between the users based on their profiles or UCPs. For example, recommendations generated based on collaborative information from users with almost identical UCPs are ranked higher by the recommendation architecture in comparison with recommendations generated from users with less similarities.

The disclosed recommendation architecture can also generate recommendations of users who would be interested in a particular item. For example, if User A has a strong interest in a particular item, the item would be recommended to User B who has a similar profile as User A. This type of user-to-item recommendations can be useful when targeting an advertisement to different users who are likely to be interested in the same advertisement.

The recommendation architecture is also capable of identifying similar content items. That is, to find content items sharing the same characteristics. Knowing that a content item is liked by the user, the recommendation architecture can find similar items and recommend them to the same user. Similar items may be identified based on common characteristics (content-based recommendations) or based on the fact that the same or similar users have shown interest in them (collaborative recommendations).

One of the novelties of the disclosed recommendation architecture is that it allows a designer to combine different types of strategies with filters and data sources in a structured manner to produce recommendations. In one embodiment, the strategies, filters and data sources are modularized so that they can be combined using union, intersection and other types of set operators. This allows the designer to be able to dynamically construct customized hybrid recommendation specifications using any combination of the available modules in the architecture. The following paragraphs details the different types of pluggable modules and how they may be combined to create a recommendation specification for generating optimal recommendations.

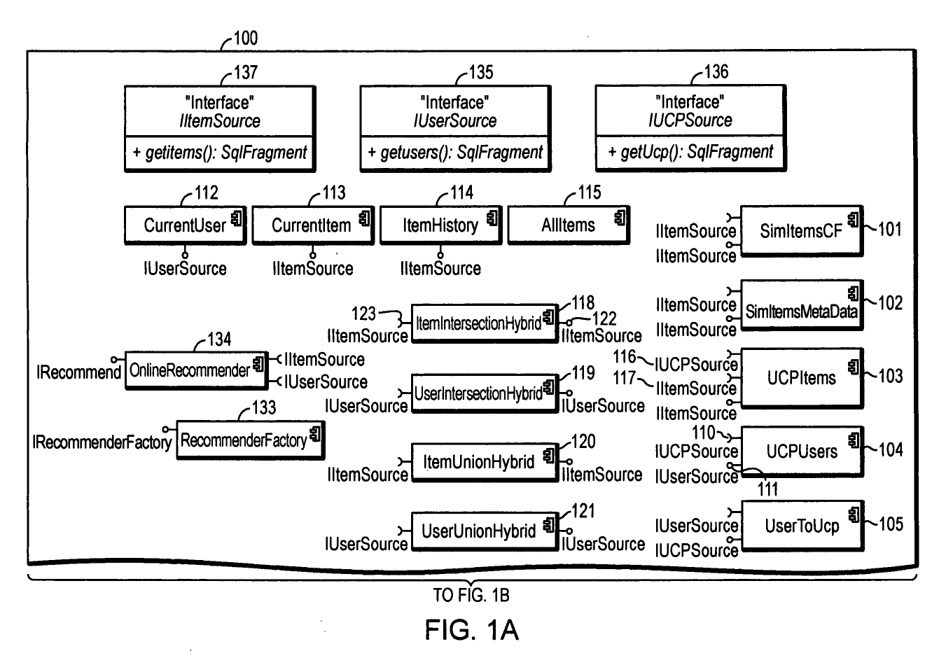

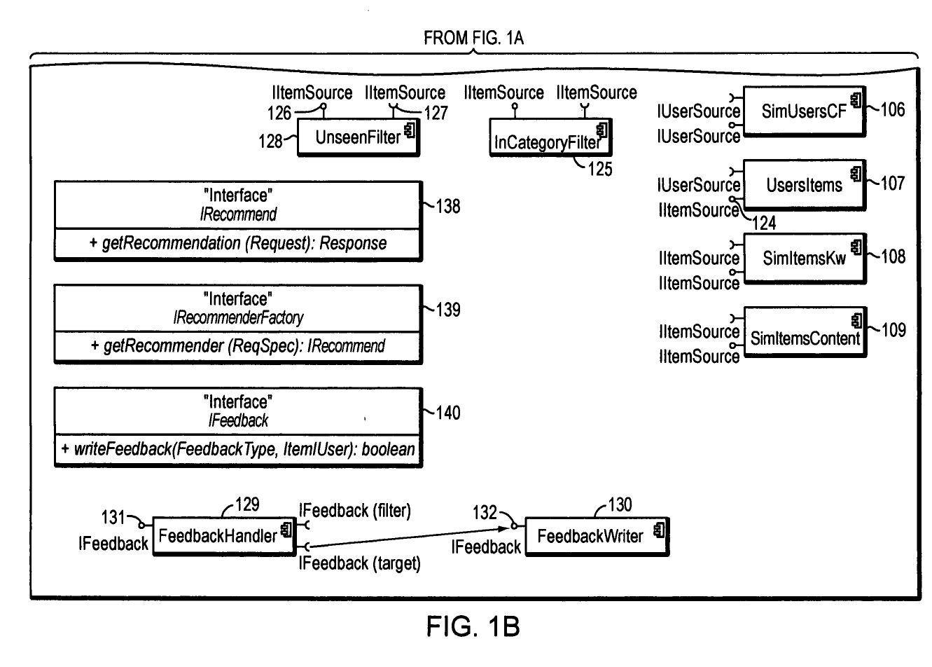

In one embodiment, as illustrated in FIG. 1, the recommendation architecture 100 is made up of a repository of different types of modules that can be combined to deliver recommendations. The different modules can be broadly categorized as data source modules and function modules. The data source modules contain data about the content items and the users. For example, the recommendation architecture 100 illustrated in FIG. 1 includes the following data source modules: the CurrentUser module 112 which stores information on the current user; the CurrentItem module 113 which stores information on the content item currently being viewed; the ItemHistory module 114 which stores information about the history of the content items; and the AllItems module 115 which include general information on all the content items accessible by the recommendation architecture 100.

Function modules contain logic and operators that can be applied to the data in the data source modules for the purpose of deriving the best possible recommendations. Function modules can be further categorized as strategy modules, filter modules, hybrid strategy modules and other system modules. The strategy modules each contains a different recommendation strategy which may be content based or collaborative based.

Referring to FIG. 1, strategy modules in the illustrated recommendation architecture include, for example, SimItemsCF 101, SimItemsMetaData 102, UCPItems 103, UCPUsers 104, UserToUCP 105, SimUsersCF 106, UsersItems 107, SimItemsKw 108, SimItemsContent 109. SimItemsCF 101 is a collaborative based recommendation strategy module that takes an item as input and outputs other similar items. The strategy implements item-to-item collaborative filtering based on the similarities between two items. The similarities are determined by the number of users interested in both items relative to the number of users interested in each item. For example, SimItemsCF 101 would recommend the TV show “Stargate Atlantis” to a fan of another TV show “Stargate” based on the data that many of the same users have both shows on their favorite lists.

In contrast, SimItemsMetaData 102 is a content based recommendation strategy module. In one embodiment, SimItemsMetaData 102 ranks and filters candidate items based on whether the metadata associated with each of the candidate items matches the metadata associated with a particular input item. For example, if the TV cartoon comedy show Futurama is associated with metadata tags “science fiction” and “comedy”, a user interested in Futurama may receive a recommendation of “The Simpsons”, a cartoon comedy, or “Star Trek”, a science fiction drama, as indicated by their respective metadata tags.

Given an item, the UCPItems strategy module 103 returns the UCPs associated with the item, i.e., the UCPs that define interest in a given content item. The UCPs of a content item indicate the characteristics of the audience for that content item. UCPs can be added explicitly to any item such that the UCP of an item becomes an aggregation of all the UCPs of the users who have shown an interest in the item. The UCPItems module 103 can be used to match users with content items by comparing the users' UCP profile to the UCP profile of the items.

The next two modules can be used in combination to find users with similar UCPs. The UserToUCP module 105 returns a user's UCPs. The UCPUsers module 104 returns users ranked according to a set of UCPs. When used together to find users having similar taste to a given user, the UserToUCP module 105 outputs the given user's UCPs, which are then used as input to the UCPUsers module 104 to find other users with similar UCPs.

The next module, SimUsersCF 106, is another collaborative based recommendation strategy that takes a user as input and retrieves other related users as output. In one embodiment, this user-to-user collaborative filtering strategy determines user similarities based on the overlap between the users' profiles. For example, if User1 likes Futurama, Star Trek and Stargate and User2 likes Futurama, Star Trek and The Simpsons, User1 and User2 are deemed to have a ⅔ overlap between their profiles. Accordingly, User1 and User2 may become recommendation partners so that items preferred by User1 but has yet unseen by User2 can be recommended to User2 by the SimUsersCF strategy module 106. In another embodiment, a UCP matching strategy may be used by the SimUsersCF module 106 to find similar users. The UCP matching strategy first obtains a first user's UCPs and then clusters other users by matching their UCPs with the first user's UCPs. For example, if User1 is interested in science fiction, the SimUsersCF module 106 would identify other users interested in science fiction and generate collaborative based recommendations by using the identified users as User1's recommendation partners.

The UsersItems module 107 retrieves all items that are of interest to a particular user, i.e., items that the user has clicked on. The SimItemsKw module 108 retrieves items similar to an input item by searching for items characterized by the same keywords as the input item. For example, given that the keyword “space” is associated with one or more items in User1's profile, the SimItemsKw module 108 is capable of supplying all candidate items associated with the keyword “space” that are available to the recommendation architecture. In the embodiment where a recommendation specification is designed to recommend search results, the SimItemsKw module 108 can be included in the specification to select all queries similar to the one entered by the user based on the keywords in the queries. This enables the recommendation specification to either recommend a more refined search query or highlight the most relevant search results based on number of clicks on each result by communities of other similar users who ran the same query. In various embodiments, similar users could be defined by item history overlap, or UCP overlap (by using the combination of the UCPUsers module 104 and the UserToUCP module 105 as previously described). The keyword match may be required to be exact or only fractional or related semantically.

Yet another strategy module in FIG. 1 is the SimItemsContent module 109. Given an item as input, the SimItemsContent module 109 retrieves other similar items based on an analysis of their content using techniques such as the term frequency/inverse document frequency (TF/IDF) method.

Each of these strategy modules includes at least one input port 110 and one output port 111. The input port 110 is adapted to receive data from other modules by being plugged into the output port of the other modules. A function module may receive data from other function modules or from a data source module. Some strategy modules may include multiple input ports. For example, the UCPItems 103 module is equipped with two input ports, one 116 for receiving UCP data and the other 117 for receiving item data. As such, the UCPItems strategy can be used to create a list of relevant items either based on item data or user UCP data.

A second type of function module is the hybrid strategy module. The hybrid strategy modules are adapted to combine the output from at least two other regular strategy modules to create a single hybrid solution. The combination operation performed by each of the hybrid strategies may be defined by a simple mathematical operator, such as union or intersection, or a more complicated function. Similar to the regular strategy modules, each of the hybrid strategy modules also has at least one input port 123 and one output 122. The input port 123 of each hybrid strategy module is adapted to be connected to the output ports of the regular strategy modules to receive processed data from these modules. The hybrid modules include logic and operators to further process the received data to generate a hybrid solution. The hybrid modules in the recommendation architecture 100 of FIG. 1 include, for example, ItemIntersectionHybrid 118, UserIntersectionHybrid 119, ItemUnionHybrid 120 and UserUnionHybrid 121. The ItemIntersectionHybrid module 118, for example, applies the intersection operator to two lists of recommended content items from two separate strategy modules to generate a single hybrid list of content items that is recommended by both of the two strategy modules. The input port 123 of the ItemIntersectionHybrid module 118 is adapted to be plugged into the output ports of the two feeding strategy modules, for example, the UCPItems 103 and UsersItems 107 modules. Similarly, the UserIntersectionHybrid module 119 produces an intersection of recommendations based on user data from at least two other strategy modules. In comparison, the ItemUnionHybrid module 120 and the UserUnionHybrid Module 121 produce a union of recommendations, respectively based on item data and user data.

Yet another type of function module is the filter module. One or more filters may be incorporated into a recommendation specification by the recommendation architecture 100 to further narrow down the field of items or users to be recommended. For example, as a part of an advertisement recommendation specification, the UnseenFilter 128 can be used to remove from the recommended list advertisements that have already been seen by the targeted user. Similarly, the InCategoryFilter 125 can be included to select only advertisements in a particular category. The filters in this embodiment also have at least one input and one output port so that they are adapted to be plugged into other modules of the recommendation architecture 100.

The data source modules, strategy modules, hybrid strategy modules and filters can be connected in any compatible way to create composite recommendation specifications. These specifications can be used for item recommendations based on purchases, search result recommendations, advertisement recommendations, item recommendations based on content similarity, and user recommendations based on their UCPs, etc. In one embodiment, the strategy modules and filter modules are implemented as SQL fragments that are assembled to form the composite recommendation algorithm. The algorithm may be persisted as a stored procedure in the database for optimal performance. The strategy modules or filter modules can be implemented as inline views in the complete SQL statement. In this embodiment, there is in effect a one-to-one mapping between the function modules of the recommendation specification and the SQL inline views.

In addition to the strategy, hybrid strategy and filter modules that make up the recommendation specifications, the recommendation architecture 100 also includes system modules that deal with outside requests and feedback. A number of interface modules may be built in the recommendation architecture to allow the other function modules to communicate with external entities. An interface defines the communication boundary between two entities. It generally refers to an abstraction that an entity provides of itself to the outside. The interfaces separate the methods of external communication from internal operation, and allow the recommendation architecture 100 to be internally modified without affecting the way it interacts with outside entities. Further, the interfaces provide multiple abstractions of the architecture, and possibly the means of translation between entities which do not speak the same language.

In one embodiment, each interface module may be implemented as an application programming interface (API). For example, as illustrated in FIG. 1, the IUserSource interface 135, the IUCPSource interface 136 and the IItemSource interface 137 are APIs for accessing external data sources for user information, UCPs and content items, respectively. The IRecommend interface 138 is an API for obtaining recommendations from the system. The IRecommenderFactory interface 139 takes a recommendation specification as input and executes the specification to produce recommendations.

Another interface module, the IFeedback interface module 140, is an API for receiving user feedback on recommendations made based on the recommendation specification. The IFeedback interface module 140 translates and forwards the feedback to the internal FeedbackHandler module 129. The FeedbackHandler 129 prepares the feedback for the FeedbackDAO module (not shown) by, for example, normalizing or filtering the feedback data. The FeedbackDAO then accesses and updates a database (not shown). In this embodiment, the FeedbackHandler 129 receives external feedback through its IFeedback port 131 and passes it on to the FeedbackWriter 130 through the FeedbackWriter's IFeedback port 132. The FeedbackWriter 130 then writes the feedback into a database (not shown). The FeedbackWriter 130 may use write-back caching and bulk merge to improve performance. If other recommendation systems have other feedback requirements they may provide filters and a different target component.

Another system module, the RecommenderFactory 133 assembles the strategy and filter modules required to execute the requested recommendation specification. The recommendation specification specifies for the RecommenderFactory 133 the necessary steps to bind the strategy and filter modules together. In one embodiment, the RecommenderFactory 133 creates the appropriate SQL representation based on the recommendation specification and makes it persistent in a SQL stored procedure. After the RecommenderFactory 133 constructs the modules in a tree structure, the OnlineRecommender 134 encapsulates the tree of strategy and filter modules and executes a recommendation request using these strategies and filters. If the recommendation specification is in the format of a SQL stored procedure, the stored procedure is executed to retrieve the recommended content items from the database. A composite recommendation specification can be represented by XML configuration.

The recommendation architecture 100 is designed to be product neutral such that recommendation specification created from the architecture can dynamically assemble modules form a pool of strategies and filters. In addition, the recommendation specification can use the request components and the feedback framework to tie the strategies and filters together and execute the recommendation specifications. The following paragraphs describe specific implementations of the recommendation architecture that are suitable for generating different types of recommendations.

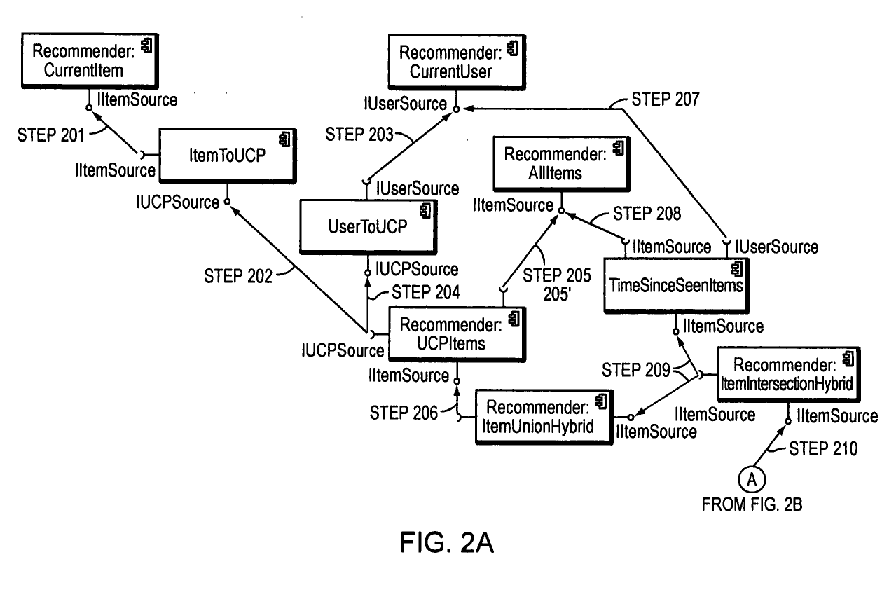

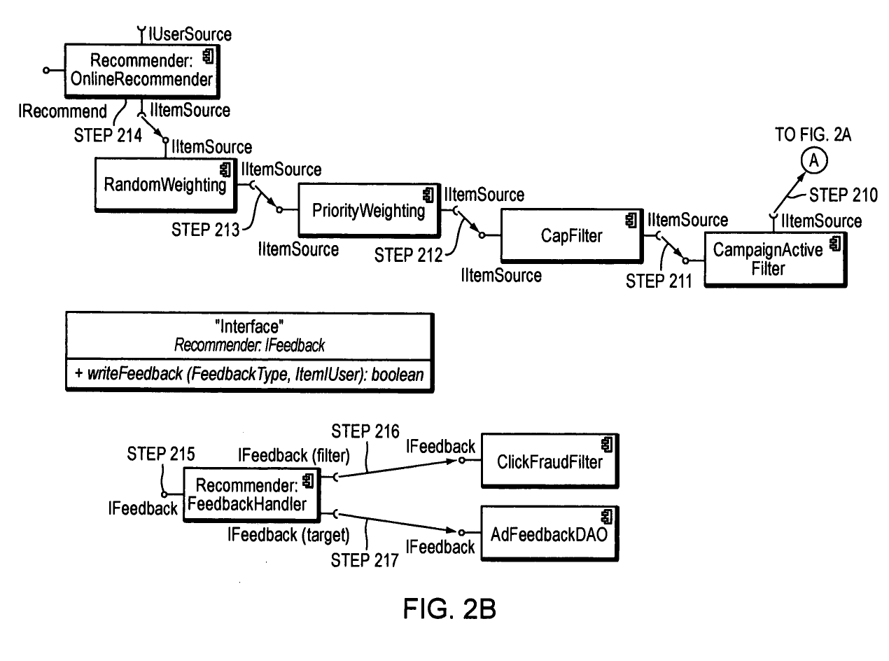

FIG. 2 illustrates the steps of making a recommendation based on a predefined recommendation specification of an advertisement personalizer where the recommendation specification is generated using an embodiment of the recommendation architecture. As illustrated in the figure and described below, data flows through the strategies and filters of the recommendation specifications in a series of steps. However, some of the steps may also be carried out simultaneously, given that their inputs and outputs are independent from each other.

Referring to FIG. 2, first, the UCP of the current portal item is acquired from the CurrentItem data source module by the ItemToUCP strategy module (Step 201) and transmitted to the UCPItem strategy module (Step 202). The UCPItems strategy module then selects from the AllItems data source module a list of advertisements that have similar item UCPs to the current item's UCP (Step 205). Similarly, the UCP of the user is acquired from the CurrentUser data source module by the UserToUCP strategy module (Step 203) and also transmitted to the UCPItems strategy module (Step 204). The UCPItems strategy module again queries the AllItems data source module to generate a second list of advertisements based on the UCP of the user (Step 205′). Next, the two lists of advertisements are combined using the union operator of the ItemUnionHybrid strategy module to create one list of advertisements to be further considered (Step 206). The combined list includes advertisements that are either related to the current content item being viewed or most likely to be of interest to the user based on the user's UCP.

Independently, information about the current user including the user's identification is also transmitted from the CurrentUser data source module to the TimeSinceSeenItems strategy module (Step 207). The TimeSinceSeenItems strategy module then polls the AllItems data source module to identify when each advertisement was last seen by the user (Step 208). Because it is more likely that a user is interested in content items to which he has not been exposed lately than in items that he has just seen, the recommendation specification includes an ItemIntersectionHybrid strategy module that takes the single list of advertisements produced by the ItemUnionHybrid strategy module and ranks the advertisements based on their elapsed time (Step 209). The intersection operator of the ItemIntersectionHybrid narrows down the list of advertisements to be output from the ItemUnionHybrid strategy module to those advertisements that have not been seen by the user for a predefined time.

The remaining advertisements are then filtered by the CampaignActiveFilter module which removes advertisements that are no longer active (Step 210) and then by the CapFilter Module which further removes advertisements that have exceeded the maximum number of times they are allowed to be displayed (Step 211). The recommendation specification also includes a PriorityWeighting filter module that ranks the remaining advertisements based on their relevance with respect to the advertisement campaign's priority (Step 212).

Optionally, a RandomWeighting filter module may be included to randomly re-rank the advertisements to ensure that the recommendations do not become focused on any one subset of the possible recommendations (Step 213). Some degree of randomness is required in order for the collaborative filtering strategies to learn and evolve and adapt to new content. The RandomWeighting filter module can also help the recommendation architecture to overcome a problem common to many collaborative recommendation systems where there is initially insufficient information about items to successfully generate recommendations. This problem exists when a recommender system is launched for the first time or when new content items are added and the users have not had a chance to see or rate the new content items.

After the list of advertisements to be recommended to the user is determined, the OnlineRecommender module executes the recommendation specification and delivers the recommended advertisements to the requesting web portal for display (Step 214).

As illustrated in FIG. 2, the ad personalizer recommendation specification also includes a number of feedback handling modules for processing user feedback on the recommended advertisements. Specifically, the FeedbackHandler receives user feedback from the host portal system (Step 215). User feedback on an advertisement may simply be an action of clicking on the advertisement or ignoring the advertisement. If a user click is detected by the FeedbackHandler, the recommendation specification may further determine whether the click is fraudulent by analyzing data on the click using the ClickFraudFilter module (Step 216). In addition, all feedbacks on recommended advertisements are processed and stored by the AdFeedbackDAO module (Step 217).

The above described recommendation specification for an ad personalizer can be implemented using SQL fragments, one for each strategy and filter modules, as exemplified in Table 1 below. Each SQL fragment can be represented by an inline view that tracks hit counts based on item ID, user ID or UCP Category. In Table 1, each of the strategy or filter modules in the left side column may be implemented using a view composed of the result of the SQL query (in pseudocode) in the corresponding right side column. Each view may be of a particular type and the corresponding modules can only be plugged together in accordance with the type of the views. Some of the stored procedures may require parameters that are not available in the database and are instead passed from external programming code, such as server side or client side scripts written to receive requests and information from the web portal.

TABLE 1
SQL Implementation of Strategy and Filter Modules

| Strategy/Filter | SQL |
|---|---|
| AllItems | select all items and their respective normalized hit counts |
| UserToUcp | select the categories associated with a user and their respective normalized |
| | hit counts |
| UCPItems | select the items and their respective normalized hit counts wherein each |
| | item and at least one UCP associated with the item are both specified in |
| | the query |
| TimeSinceSeemItems | select items seen by a user and sort the items by the time elapsed from |
| | their last updates |
| PortalItemToUcp | select categories and their respective normalized hit counts |
| UnionItemHybrid | select items and their respective hit counts where the items are in either |
| | query 1 or query 2 |
| IntersectionItemHybrid | select items and their respective hit counts where the items are in both |
| | query 1 and query 2 |
| CampaignActiveFilter | select items that are designated active for a given ad campaign |
| CampaignPriorityWeighting | select items that are designated active for a given ad campaign and assign |
| | priority to each |
| AdRandomWeighting | select items and apply random weight to each item |
| Capfilter | select items that have a cap greater than 1 |
| Rank | select and sort items based on their normalized hit counts |

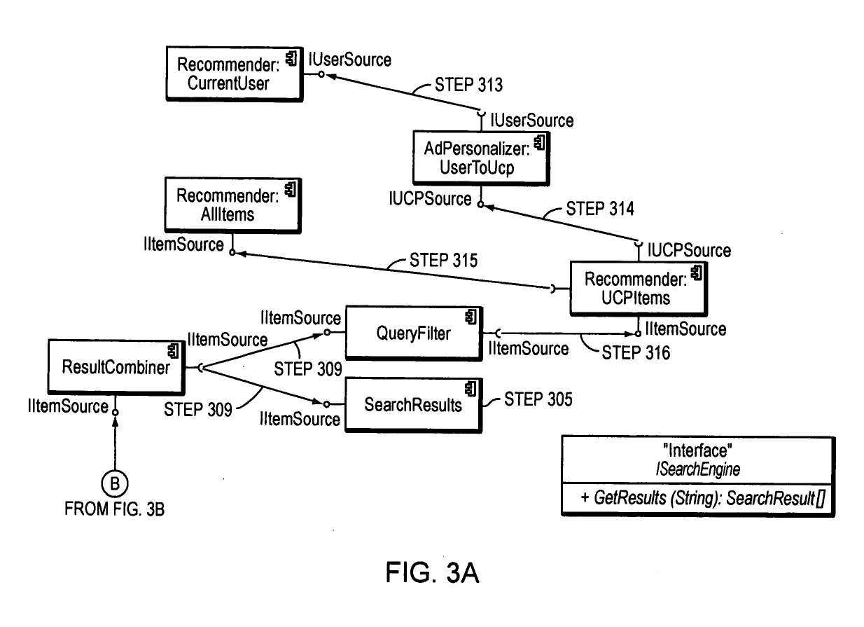

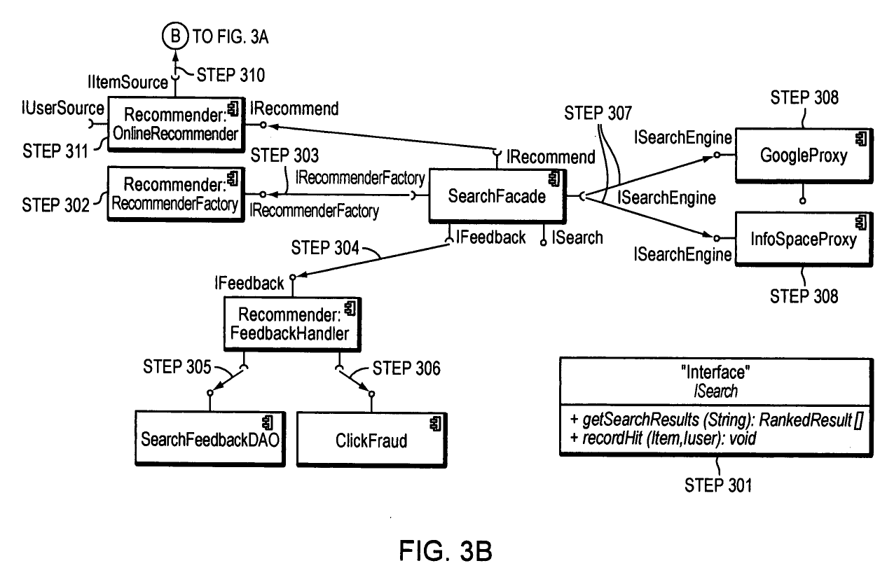

In another example, a recommendation specification tailored for a search system is illustrated in FIG. 3. The search system retrieves search results from external search engines like Google. Depending on the specificity of the search query, it is not uncommon for the search engine to generate a large number of search results in response to the query. Some of these results are bound to be more relevant than others. Thus, it is essential for a search engine to be able to predict and recommend the most relevant results to the user. In the disclosed embodiment, search results are ranked based on other similar search results that have previously been clicked on by other users.

Referring to FIG. 3, upon receiving a user request to the search system through the ISearch interface module (Step 301), the recommendation architecture invokes the RecommenderFactory to recommend search results to the user using the illustrated recommendation specification (Step 302). The RecommenderFactory strategy module first forwards the user request to the SearchFacade strategy module which determines whether the user request is feedback on one of the search results, e.g., a user click (Step 303). If the request is indeed user feedback, the SearchFacade strategy module redirects the feedback information to the internal FeedbackHandler strategy module (Step 304). The FeedbackHandler module is responsible for updating the SearchFeedbackDAO strategy module which further processes and stores the user feedback information for future use (Step 305). Optionally, the feedback information is verified by the ClickFraud module, which filters out fraudulent feedback, before being processed by the SearchFeedbackDAO (Step 306).

In contrast, if the SearchFacade strategy module determines that the user request is a new search query, the SearchFacade strategy module forwards the query to one of the available external search engines using the ISearchEngine interface module (Step 307). As illustrated in FIG. 3, the recommendation specification may also include customized proxy modules, such as GoogleProxy and InfoSpaceProxy modules, to communicate and receive data from the respective external search engines, i.e., Google and InfoSpace (Step 308). The search results returned by the external search engines are then re-ranked by the ResultCombiner strategy module based on internally generated recommendations (Step 309) to produce the most relevant search results in response to the user request (Step 310). These internally generated recommendations are produced using a combination of different types of strategy modules and filter modules available to the recommendation architecture. In this embodiment of the recommendation specification, as illustrated in FIG. 3, data on the current user is extracted from the CurrentUser data source module and passed to the UserToUCP strategy module (Step 313). The UserToUCP module determines the UCPs of the current user and passes that information to the UCPItems strategy module (Step 314). Based on the user UCPs, the UCPItems strategy module obtains a list of relevant content items from the AllItems data source module (Step 315). The selected items are then passed through a QueryFilter module so that only items relevant to the user's query are returned (Step 316). After the ResultCombiner strategy module produces the most relevant search results, the OnlineRecommender module executes the recommendation specification and delivers the recommended search results to the requesting user (Step 311).

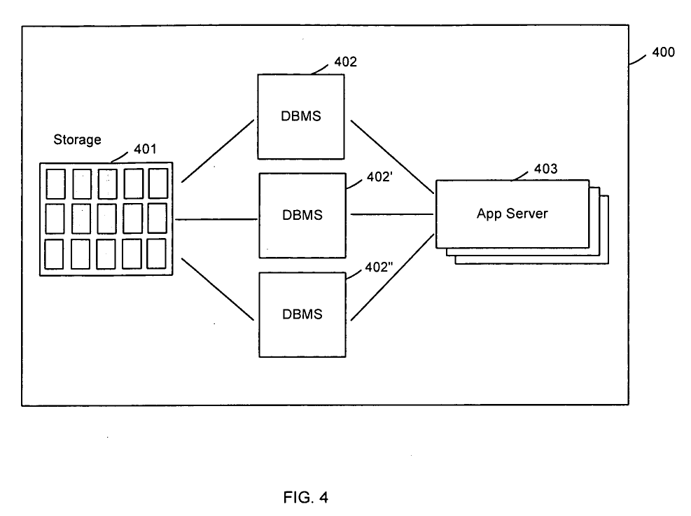

Recommendation specifications designed to recommend other types of content items can be created similarly by connecting a number of the available modules. Preferably, the recommendation architecture is scalable in terms of dataset size, request load, and recommendation strategy complexity. An information system such as a database management system can be implemented to satisfy the requirement of handling large datasets. FIG. 4 illustrates one hardware embodiment of the recommendation architecture 400. The recommendation architecture includes a data storage component 401 for storing user data, content item data and any other data that may be packaged into one or more data source modules to be later incorporated in recommendation specifications. Storage capacity and performance of the data storage component 401 may be increased by increasing the number of disk spindles, cache, and in extreme cases, storage units. The data storage 401 may be one of the commercially available relational database or object database.

As illustrated in FIG. 4, one or more enterprise-grade database management systems (DBMS) 402, 402′, 402″ are in communication with the data storage component 401. The DBMS's manage the data in the storage component 401 and deliver sufficient scalability in data processing. Because a DBMS is designed primarily to process data, it is also much easier to implement a recommendation architecture in a DBMS than in any other component of the system because the DBMS is adapted to store both the required programming logic and data in the same place. A DBMS may be scaled at database node level through clustering, which in turn scales the CPU processing and caching. The DBMS's 402, 402′ and 402″ are also each in further communication with at least one Application Server 403. The Application Server 403 requests and receives recommendation from the DBMS based recommendation architecture. In one embodiment, the Application Server 403 may be a web server hosting a web portal and the recommended content items, such as advertisements and search results, are displayed on personalized pages of the portal by the Application Server 403.

In general, the less processing that needs to be performed by the system to satisfy user requests the faster the system can respond, regardless of whether the processing is performed in the clients, the Application Server 403, the DBMS's 402, 402′, 402″, or in the storage component 401. Recommendations are not required to be exact and therefore lend themselves to pre-computations which can be cached. The following forms of pre-computations can be used in implementing the disclosed recommendation architecture: 1) offline building of pre-computed result sets in the database at scheduled intervals; and 2) result caching in the Application Servers 403 to limit the number of calls that are forwarded to the DBMS's 402, 402′, 402″ every time a recommendation request is made. The first form is in effect caching inside the database. The result sets are used by the online recommendation specifications to quickly respond to recommendation requests. The second form eliminates communications between the Application Server 403 and the DBMS's 402, 402′, 402″. Instead of repeatedly requesting recommendations in a session, a single request is made and the recommendations returned are cached in the Application Server 403 and can be retrieved at any time later in the same session.

More specifically, caching in the Application Server can either be done as result caching or data caching. Result caching keeps the logic in one place (e.g., the DBMS's), reduces request load, and can be made relatively seamlessly. Caching can be done against a key made up of external parameters such as user ID, UCP, etc. The key calculation may either be per cacheable entry or be fuzzy. Result caching is per user and the result cache can delete entries that are returned to give the user a list of fresh recommendations. In addition, result caching is not limited to the Application Server.

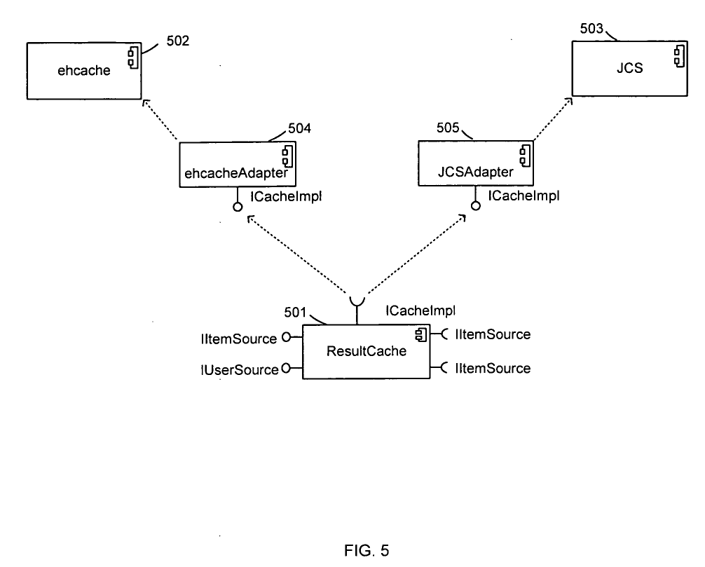

An embodiment of the caching component of the recommendation architecture is illustrated in FIG. 5. Referring to FIG. 5, the ResultCache component 501 plugs into a composite strategy and offers seamless caching to the Application Server (not shown in FIG. 5) looking for recommendations. The caching strategy can be a mixture of time limitation and least-frequently-used. The result cache uses a proven cache implementation such as the ehcache module 502 or the JCS module 503, as illustrated in FIG. 5. Each of these modules is in communication with the ResultCache component 501 via its respective adapter 504, 505. Even though this exemplary cache component supports distributed caching, distributed caching is not a required feature because most caching is user specific and user sessions are associated with individual Application Servers in the application cluster. Result cache provides recommendations that have been retrieved by previous activity. It contains a list of recommendations that are tied to a key. The key matching algorithm returns a value from 0 to 1 where 1 indicates a perfect match. The algorithm can be specific to the data being cached in order to allow the key matching algorithm to be turned to the underlying recommendation algorithm. When a request is checked against the Result cache, the cache entry with the highest relevance is determined. If this relevance is higher than the cache threshold, the cache is used. The cache threshold is a dynamic value that depends on recommendation algorithm performance. If the system is performing poorly, the threshold decreases to make it likelier to pick results out of cache. These thresholds decrease are logged and reported on so a customer can see the impact of having a poorly performing system. The table below indicates how result caching would be implemented for products with a recommendation core.

TABLE 2
Caching Strategies for Recommendation Specifications

| Product | Recommendation Strategy | Caching Strategy |
|---|---|---|
| AdPersonalizer | Ads are selected based on Ad | Get x ads per Ad Space category |
| | Space category, User Id (UCP | for the user, the cache key is Ad |
| | and seen items) | Space category + user, remove |
| | | items from the cache as they are |
| | | returned. |
| | | If the Ad Space category is not |
| | | used, then cache key is user and |
| | | remove items from the cache as |
| | | they are returned. |
| Search | Search queries are selected based | Get x recommendations for the |
| | on user's UCP and a query string. | user, the cache key is UCP and |
| | | search string. Return cached |
| | | results if available. |
| Recommender CF | The recommendations are | Not feasible. Low predicted hit |
| “current item” | selected based on an item and | rate because the user and item |
| | filtered on the user's item history. | combination is not likely to occur |
| | | more than once during a session. |
| Recommender CF | The recommendations are | Get x recommendations for the |
| “favourite items” | selected based on the user's item | user, the cache key is user id, |
| | history. | remove items from the cache as |
| | | they are returned. |
| Recommender meta | The recommendations are | Not feasible. Low predicted hit |
| data | selected based on meta data and | rate because the user and meta |
| | filtered on the user's item history. | data combination is not likely to |
| | | occur more than once during a |
| | | session. |

As described above, the disclosed recommendation architecture provides a flexible structure adapted to create customized recommendation specifications by dynamically connecting a number of different available data source modules and function modules in response to a specific request. Further, the architecture offers unprecedented scalability and performance by relying extensively on DBMS technology and incorporating sophisticated caching mechanisms.

Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

What is claimed is:

1. A method for making an online content recommendation comprising the steps of:
providing a plurality of data source modules having data;
providing a plurality of function modules, each function module adapted to be connected to at least one of the modules selected from the plurality of data source modules and other function modules;
receiving a recommendation request;
dynamically connecting at least one of the plurality of the data source modules and at least one of the plurality of function modules in response to the recommendation request; and
generating the recommendation by using the connected at least one data source module and the at least one function module.

2. The method of claim 1 further comprising the step of creating a recommendation specification, the recommendation specification defining at least one data source module and at least one function module for making the recommendation in response to the recommendation request.

3. The method of claim 1 further comprising the step of receiving user feedback on the recommendation.

4. The method of claim 1 wherein at least one of the plurality of data source modules includes a user profile.

5. The method of claim 1 wherein at least one of the plurality of data source modules includes an item profile.

6. The method of claim 1 wherein at least one of the plurality of function modules is a filter module.

7. The method of claim 1 wherein at least one of the plurality of function modules is a strategy module.

8. The method of claim 1 wherein at least one of the plurality of function modules is a hybrid strategy module.

9. The method of claim 1 wherein the recommendation is a personalized advertisement.

10. The method of claim 1 wherein the recommendation is a personalized search result.

11. The method of claim 1 further comprising the step of caching the recommendation with respect to the user and the user action.

12. A system for making an online content recommendation, the system comprising:
a plurality of data source modules having data;
a plurality of function modules, each function module adapted to be connected to at least one of the modules selected from the plurality of data source modules and other function modules;
a recommendation request receiving module adapted to receive a request for recommendations;
a recommendation factory adapted to dynamically assemble at least one of the plurality of function modules and at least one of the plurality of data source modules in response to the recommendation request, the recommendation factory in communication with the recommendation request receiving module; and
an online recommender for generating a recommendation using the assembled at least one function module and at least one data source module, the online recommender in communication with the recommendation factory.

13. The system of claim 12 further comprising a recommendation specification generator adapted to generate a recommendation specification in response to the request for recommendation, the recommendation specification generator in communication with the user input module.

14. The system of claim 12 further comprising a feedback handler for managing user feedbacks in response to the recommendation.

15. The system of claim 12 wherein at least one of the data source modules includes a user profile.

16. The system of claim 12 wherein at least one of the plurality of data source modules includes an item profile.

17. The system of claim 12 wherein at least one of the plurality of function modules is a filter module.

18. The system of claim 12 wherein at least one of the plurality of function modules is a strategy module.

19. The method of claim 12 wherein at least one of the plurality of function modules is a hybrid strategy module.

20. The system of claim 12 wherein the recommendation is a personalized advertisement.

21. The system of claim 12 wherein the recommendation is a personalized search result.

22. The system of claim 12 further comprising a caching module adapted to cache the recommendation with respect to the user and the user request.

23. The system of claim 12 where the recommendation request receiving module is adapted to receive search results from a search engine.

24. The system of claim 12 where the recommendation request receiving modules is adapted to communicate with an advertisement provider.
